(19) United States
(12) Patent Application Publication
(10) Pub. No.: US 2026/0352746 A1
(43) Pub. Date: Nov. 5, 2026

(54) METHODS, ARCHITECTURES, APPARATUSES AND SYSTEMS FOR USER PLANE PROTOCOL AND HEADER STRUCTURE

(71) Applicant: InterDigital Patent Holdings, Inc., Wilmington, DE (US)

(72) Inventors: Samuli Turtinen, Ii (FI); Faris Alfarhan, Montreal (CA); Tuong Hoang, Montréal (CA); Francois Periard, Montréal (CA); Martino Freda, Laval (CA); Brian Martin, Farnham (GB); Keiichi Kubota, Setagaya-Ku (JP); Diana Pani, Montréal (CA); Ghyslain Pelletier, Montréal (CA); Paul Marinier, Brossard (CA); Chia-Hung Wei, Chesterbrook, PA (US)

(21) Appl. No.: 19/198,469

(22) Filed: May 5, 2025

(51) Int. Cl. H04L 69/22; H04W 28/02

(52) U.S. Cl. CPC H04L 69/22; H04W 28/0268

(57) ABSTRACT

A transmission procedure may include to generate, from a first data unit for transmission, a second data unit which includes a first header and the first data unit. For example, the first header may be generated according to a type of the first data unit and/or information to be encoded in the first header. Based at least in part on a type of the second data unit and/or a type of the first header, a second header associated with the second data unit may be generated. For example, the second header includes information indicating a type of the second data unit and/or the type of the first header. A third data unit may be generated that includes at least a fourth data unit. For example, the fourth data unit may include the second header and the second data unit. The procedure may include to send the third data unit.

### BACKGROUND

The present application is related to the fields of communications, software and encoding, including, for example, to methods, architectures, apparatuses, systems directed to next generation (e.g., 6G) systems, and, more specifically, to Layer 2 (L2) (e.g., protocol data unit (PDU)) processing, interactions, and headers.

The current user plane interface, originally developed in 3G and 4G, and inherited to 5G/NR, was designed to meet best effort data with minimum and guaranteed bit rate requirements, and not much beyond such requirements. A need exists for a next generation (e.g., new) L2 user plane interface in view of aspects related to computational efficiency, Quality of Service (QoS), latency, reliability, support for different data types, power consumption, scheduling, capacity, congestion, and/or application layer awareness.

### BRIEF SUMMARY

Briefly stated, in one embodiment, a transmission procedure may include to generate, from a first data unit for transmission, a second data unit which includes a first header and the first data unit. For example, the first header may be generated according to a type of the first data unit and/or information to be encoded in the first header. The procedure may include to generate, based at least in part on a type of the second data unit and/or a type of the first header, a second header associated with the second data unit. For example, the second header includes information indicating a type of the second data unit and/or the type of the first header. The procedure may include to generate a third data unit including at least a fourth data unit. For example, the fourth data unit may include the second header and the second data unit. The procedure may include to send the third data unit.

In one embodiment, a transmission procedure may include to determine by a higher layer entity a packet to be transmitted. The higher layer (e.g., sub-layer) entity may generate a PDU including a first header and the packet to be transmitted. The first header may be dependent on the type of the packet and/or one or more pieces of information to be encoded in the header. The higher layer entity may indicate to a lower layer (e.g., sub-layer) entity the type of the PDU (or the lower layer service data unit (SDU)) and/or the type of the header in the PDU. The lower layer entity may generate, at least in part based on the indication by the higher layer entity, a second header (or a sub-header) for the SDU. For example, the second header may include information on the type of the SDU (or the higher layer PDU) and/or the type of the first header. The lower layer entity may generate a PDU. For example, this PDU may include at least a sub-PDU, and the sub-PDU may include the first header, the second header, and the SDU.

In one embodiment, a reception procedure may include to receive a first data unit. For example, the first data unit may include a second data unit including a first header, a second header, and a third data unit. The procedure may include to determine, based on the first header, a type of the third data unit and/or a type of the second header associated with (e.g., of) the third data unit. The procedure may include to decode the third data unit according to the determined type of the third data unit and/or the determined type of the second header.

In one embodiment, a reception procedure may include to receive a PDU by a lower layer entity. This PDU may include a sub-PDU, and the sub-PDU may include a first header, a second header, and an SDU. The lower layer entity may indicate to a higher layer entity the type of the SDU (or the higher layer PDU) and/or the type of the second header. For example, the lower layer may determine the indicated information from the first header. The higher layer entity may determine, based on the indicating by the lower layer entity, the type of the PDU and/or the type of the second header in the PDU, and decode the PDU based on the determined information (e.g., type of the PDU and/or type of the second header in the PDU).

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a protocol stack diagram illustrating an example of processing at various protocol layers at a transmitting entity, according to one or more embodiments of the present disclosure;

FIG. 3 is a protocol stack diagram illustrating an example of processing at various protocol layers at a receiving entity, according to one or more embodiments of the present disclosure;

FIG. 4 is a protocol stack diagram illustrating another example of processing at various protocol layers at a transmitting entity, according to one or more embodiments of the present disclosure;

FIG. 5 is a protocol stack diagram illustrating another example of processing at various protocol layers at a receiving entity, according to one or more embodiments of the present disclosure;

FIG. 6 is a lower layer header diagram illustrating an example of a lower layer PDU sub-header, according to one or more embodiments of the present disclosure;

FIG. 7 is a lower layer header diagram illustrating another example of a lower layer PDU sub-header, according to one or more embodiments of the present disclosure;

FIG. 8 is a lower layer header diagram illustrating another example of a lower layer PDU sub-header, according to one or more embodiments of the present disclosure;

FIG. 9 is a lower layer header diagram illustrating another example of a lower layer PDU sub-header, according to one or more embodiments of the present disclosure;

FIG. 10 is a higher layer header diagram illustrating an example of a higher layer data PDU header, according to one or more embodiments of the present disclosure;

FIG. 11 is a higher layer header diagram illustrating another example of a higher layer data PDU header, according to one or more embodiments of the present disclosure;

FIG. 12 is a higher layer header diagram illustrating another example of a higher layer data PDU header, according to one or more embodiments of the present disclosure;

FIG. 13 is a higher layer header diagram illustrating an example of a higher layer control PDU header, according to one or more embodiments of the present disclosure;

FIG. 14 is a higher layer header diagram illustrating another example of a higher layer data PDU header, according to one or more embodiments of the present disclosure;

FIG. 15 is a data structure diagram illustrating an example header and data unit hierarchy, according to one or more embodiments of the present disclosure;

FIG. 16 is a procedural diagram illustrating an example transmission procedure, according to one or more embodiments of the present disclosure;

FIG. 17 is a procedural diagram illustrating an example reception procedure, according to one or more embodiments of the present disclosure;

FIG. 18 is a procedural diagram illustrating another example transmission procedure, according to one or more embodiments of the present disclosure; and

FIG. 19 is a procedural diagram illustrating another example reception procedure according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

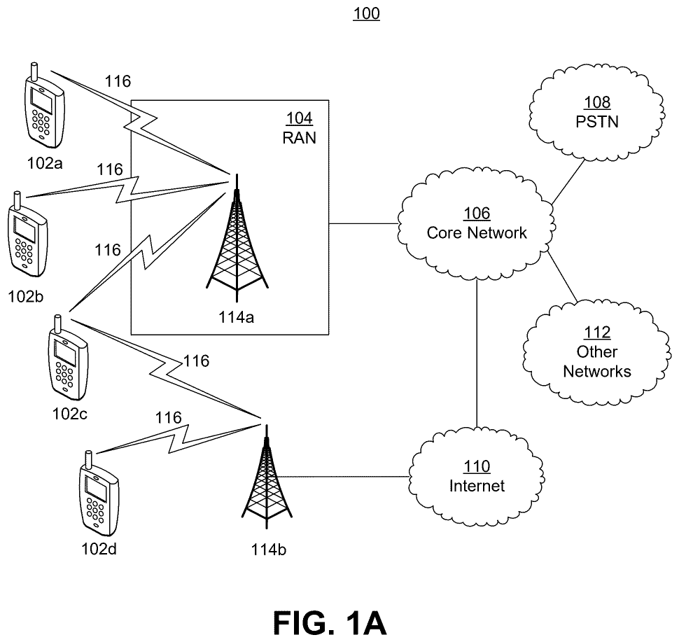

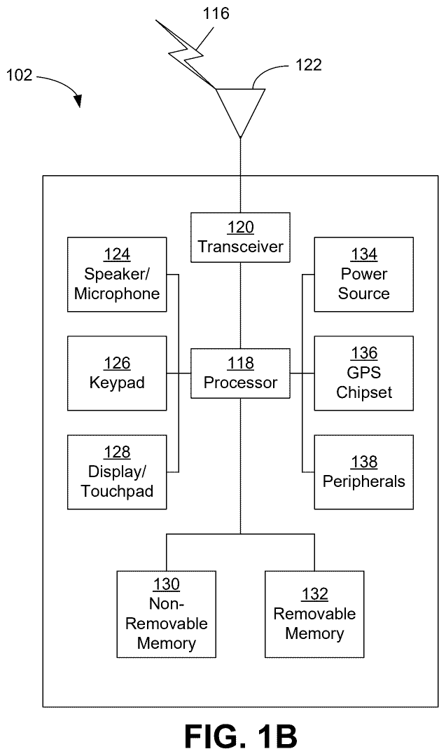

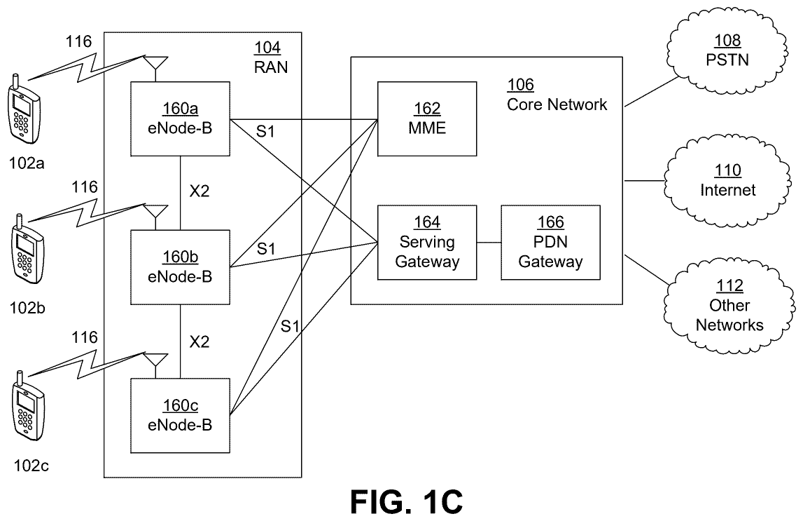

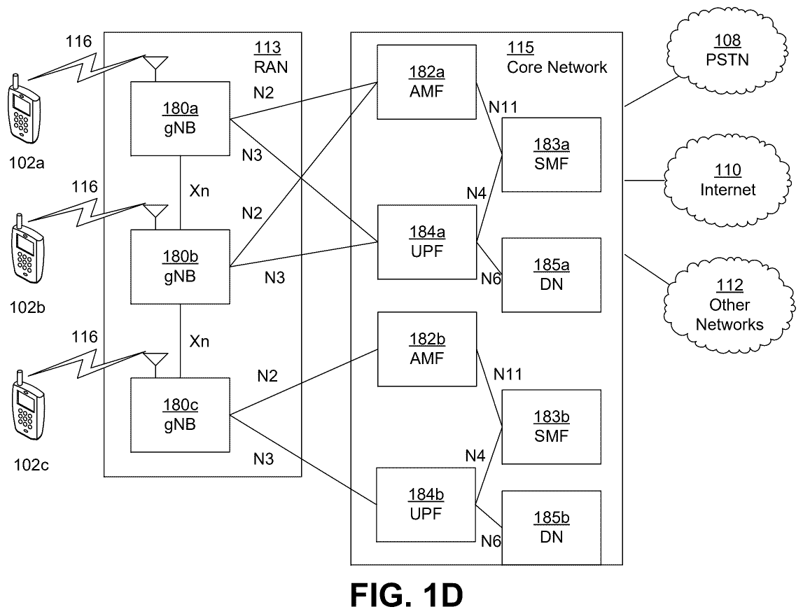

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

It may be beneficial to provide a next generation L2 user plane interface. As described herein, solutions are provided which may relate to any of L2 PDU processing procedures, L2 interactions (e.g., with other layers of the protocol stack), and the structures (e.g., formats) applicable to L2 headers.

For example, L2 user plane interfaces may consider computational efficiency. L2 processing scales linearly with packet rate. As the packet rate increases, it can significantly boost processing demands and power consumption, creating overhead challenges for both the network and WTRUs. Layering and isolating the L2 protocols from each other creates an overly hierarchical structure leading to manufactured latencies and increased computational complexity.

For example, L2 user plane interfaces may consider QoS, latency, and/or reliability. L2 interfaces may support variable QoS requirements, low latency, and/or high reliability, including for (e.g., extreme) applications such as extended reality (XR), virtual reality (VR), augmented reality (AR), hyper reliable low latency communication (HRLLC), and enhanced ultra reliable low latency communication (eURLLC). Retransmissions currently are duplicated in multiple layers. Retransmissions at higher layers (e.g., RLC) are too slow to meet latency sensitive applications (e.g. XR). Retransmissions are also quite rigid (retransmission data may be exactly the same, such as same TB size, same carrier, etc.). QoS attributes can be assigned to each data set/channel, including the usual key performance indicators (KPIs): priority, prioritized bit rate (PBR), packet delay budget (PDB), packet error rate (PER), bit loss error rate (BLER), and additional KPIs: packet set delay budget (PSDB), dependencies to other sets, strict delay, energy consumption, and complexity metrics. As one example, a L2 interface may enable elastic Quality of Experience (QoE) levels varying (e.g. somewhere between the minimum data rate/guaranteed bit rate (GBR) and maximum data rate), though QoS is met. For example, QoE may (e.g., must) meet a minimum requirement. For example, a WTRU 102 may start transmission of data with a given QoE level that is higher, then as the WTRU 102 moves out of coverage, experiences cell congestion, or when the data rate drops, the WTRU 102 may then reduce the QoE level or reduce the number of data packet sets that are transmitted (e.g. if there are multiple or multi-modal streams, the WTRU 102 may drop one stream that is not necessary to meet the minimum QoE level while still maintaining the QoS).

For example, example L2 user plane interfaces may consider support of different data types. Currently signaling radio bearer (SRB) and data radio bearer (DRB) data are differentiated, and treatment of user plane (UP) data QoS is controlled by QoS flow to DRB mapping. Once mapped to a DRB, packet treatment is done semi-statically. New applications (e.g. AI/ML, XR, sensing, volumetric video) may introduce new data types, potentially within a QoS flow. The NR UP does not provide differentiated treatment for more important and/or systematic packets (e.g. for a QoS flow). Data sets may be classified by type (e.g. control, data, sensory, AI/ML data). As an example, a L2 interface may (e.g., shall) support means to avoid unnecessary data transmission, and handling of QoS/QoE dependencies between different data types (e.g., UP, CP, system data) and dependencies between data of the same type

For example, L2 user plane interfaces may consider power consumption, such as at the WTRU and/or at the network. The L2 protocol may (e.g., should) enable both WTRU and network power savings. DRBs are not elastic in terms of resource allocation and mapping across cells and cell groups. As an example, a L2 interface may (e.g., shall) therefore support means for timely WTRU reachability, WTRU processing chain power consumption, and/or balancing of network and WTRU energy consumption. For example a PDU should be able to be transmitted/received in a more dynamic manner, such as without rigid restrictions on DRB, carrier, or cell group

For example, example L2 user plane interfaces may consider scheduling, capacity, and/or congestion. Configured grants are responsive to delay bounds but consume heavy overhead. Transmission on dynamic grants following a scheduling request (SR) or buffer status report (BSR) can incur delays. LCP is based on leaky bucket uplink traffic shaping, and doesn't consider inter-packet associations, latency bounds, or congestion.

For example, example L2 user plane interfaces may consider application layer awareness. The NR UP does not provide differentiated treatment for more important packets (e.g., relevance may vary over time or over other control reception, such as within a bearer). Several applications may generate packets that have different importance. Existing L2 protocols have not evolved with new application layer transport protocols (e.g., QUIC developed for faster, more reliable, and more efficient data transfer). Awareness may include RAN awareness of application QoS and/or QoE metrics and/or data (e.g., events, important/relevant data) and the application being aware of RAN dynamic conditions (e.g., radio conditions, congestion, cell load, etc.). For example, an application itself may adjust the rate of a packet set, and in such case the WTRU 102 may not change the underlying QoE level (e.g., when the video rate is decreased by the application). This may mean that the WTRU 102 may or may not be aware of what the application layer rate or rate adjustments are, but the WTRU 102 may know the required QoE level (e.g., no awareness in the first case, but awareness in the second way). For example, awareness may (e.g., also) involve awareness of application flow dependencies and synchronization and other system data (e.g., sensory, ML, CP triggered events like handover, etc.).

Conventionally (e.g., in NR and LTE), the L2 protocols'PDU structures are self decodable and the header field(s) within a PDU, or sub-PDU within a MAC PDU, of a L2 protocol may change both the interpretation as well as the size of the PDU header. Some examples from NR include the (i) the F field in MAC sub-header indicating whether a 1- or 2-byte length (L) field is encoded in the MAC sub-header; (ii) the D/C bits in radio link control (RLC) and packet data convergence protocol (PDCP) PDU headers indicating whether the PDU includes a data or control PDU; and (iii) the segment indication (SI) in RLC PDU header indicating if SO field is present in the RLC PDU header.

With the intensive data rates envisioned for 6G, conventional approaches may be a blocking aspect for an implementation friendly design. To enable hardware (HW) friendly processing, it may be beneficial to provide solutions where header structures may (e.g. should) not be varying based on bit indications within the header (e.g., the header size should be fixed to a far extent). More generally, it may be beneficial to provide solutions to enable a future proof header structure that is low in terms of overhead and computational complexity, while allowing front loaded preprocessing of transport block (TB) headers. It may (e.g., also) be beneficial to provide solutions to enable a non-rigid header structure that may quickly adapt to changing data.

In certain representative embodiments, L2 protocol designs are provided to meet the intensive data rate requirements expected for next generation (e.g., 6G) systems.

### Overview

In certain representative embodiments, a WTRU 102 may implement a procedure to handle L2 PDU headers. In certain representative embodiments, a base station (e.g., a gNB 180, a 6G NB, etc.) may implement a procedure to handle L2 PDU headers. It should be apparent from the description herein that the described techniques and procedures may be applicable to uplink (UL) and downlink (DL) communications.

In certain representative embodiments, a lower layer PDU header (e.g., sub-header) may provide information about how a higher layer entity may (e.g., shall) decode a higher layer PDU and/or a higher layer PDU header.

In certain representative embodiments, a transmitting device (e.g., WTRU 102, 6G NB) may determine (e.g., by a higher layer protocol entity) a packet is to be transmitted. For example, the packet may be any of a data service data unit (SDU), a packet received from upper layers, a control SDU, or a packet generated by the higher layer entity. For example, a higher layer (e.g., protocol) entity may be any of a radio link control (RLC), a packet data convergence protocol (PDCP), or a service data adaptation protocol entity.

In certain representative embodiments, the transmitting device may generate (e.g., by the higher layer entity) a PDU including a first header and the packet to be transmitted. For example, the (e.g., first) header may be dependent on a type of the packet and/or (e.g., one or more information) to be encoded in the (e.g., first) header. For example, the type of the packet may be a data SDU, a control SDU, or the like. For example, the information (e.g., to be) encoded in the (e.g., first) header may include any of (i) one or more of sequence numbers (SNs), (ii) a data flow identifier (ID) (e.g., a QoS flow ID (QFI)), (iii) segmentation information (e.g., segmentation information (SI) and/or segment offset (SO)), (iv) a polling, reordering, and/or in-sequence requirement, (v) concatenation information, (vi) security information (e.g., message authentication code for integrity (MAC-I) or key), and/or reflective QoS information.

In certain representative embodiments, the transmitting device may indicate (e.g., by the higher layer entity to a lower layer entity) a type of the PDU, or the (e.g., lower layer) SDU, and/or the type of the first (e.g., overall) header in the PDU. For example, indicating may be implicit, such as based on one or more logical channels associated with one or more types of PDUs or headers of PDUs. For example, indicating may be an explicit indication (e.g., by the higher layer entity to the lower layer entity) about the type of the PDU, the (e.g., lower layer) SDU, or the type of the header in the PDU. For example, an indication may include an index to be encoded (e.g., by the lower layer entity) into a second header (e.g., the lower layer entity may not need to know what the index actually means and the index is just used to convey such information to a receiving entity). For example, a lower layer entity may be a MAC or RLC entity. For example, the higher layer entity may indicate to the lower layer entity whether one or more header field needs to be generated, can be skipped, or can be reused and/or determined from higher layer header information (e.g. a sequence number, concatenation or segmentation related headers).

In certain representative embodiments, the transmitting device may generate (e.g., by the lower layer entity), based (e.g., at least in part) on the indicated information (e.g., the indication by the higher layer entity, a second header (or a sub-header) for the SDU. For example, the second header may include information indicating the type of the SDU, the (e.g., higher layer) PDU, and/or the type of the first header. For example, the information may indicate whether the (e.g., lower layer) SDU or (e.g., higher layer) PDU is any of a data PDU, a control PDU, PDU with a special header type, segmented PDU, concatenated PDU, etc. For example, the information may (e.g., alternatively or also) indicate whether the header in the PDU is any of a data PDU header, a control PDU header, a segmentation header, a special header, a concatenated PDU header, etc. For example, a 2-bit field may be used for this purpose. In certain representative embodiments, the information may be related to the upper layer header processing and/or a structure assumption. For example, if there are different assumptions configured, the lower layer header may point to a header assumption of the higher layer (or vice-versa), such as to indicate the header structure used by the higher layer.

In certain representative embodiments, the transmitting device may generate (e.g., by the lower layer entity) a PDU. The PDU may include at least a sub-PDU, and the sub-PDU may include the second header and the SDU.

In certain representative embodiments, a receiving device (e.g., WTRU 102, 6G NB) may receive (e.g., by a lower layer entity) a PDU. The PDU may include a sub-PDU, and the sub-PDU may include a first header and an SDU.

In certain representative embodiments, the receiving device may determine (e.g., by the lower layer entity) information from the first header. For example, the information may include a type of the SDU (or corresponding higher layer PDU) or a type of a second header. For example, the information may indicate whether the (e.g., lower layer) SDU or (e.g., higher layer) PDU is any of a data PDU, a control PDU, PDU with a special header type, segmented PDU, concatenated PDU, etc. For example, the information may (e.g., alternatively or also) indicate whether the header in the PDU is any of a data PDU header, a control PDU header, a segmentation header, a special header, a concatenated PDU header, etc. For example, a 2-bit field may be used for this purpose. In certain representative embodiments, the information may be related to the upper layer header processing and/or a structure assumption. For example, if there are different assumptions configured, the lower layer header may point to a header assumption of the higher layer (or vice-versa), such as to indicate the header structure used by the higher layer.

In certain representative embodiments, the receiving device may indicate (e.g., by the lower layer entity to a higher layer entity) the type of the SDU, the higher layer PDU, and/or the type of the second header. For example, the indicating may be implicit, such as based on one or more logical channels associated with one or more types of PDUs or headers of PDUs. For example, the indicating may (e.g., alternatively) be an explicit indication (e.g., by the lower layer entity to the higher layer entity) about the type of the PDU, the lower layer SDU, or the type of the header in the PDU. For example, the lower layer entity may be a MAC or RLC entity. For example, the lower layer entity may indicate whether one or more header fields are present, skipped, can be reused, and/or determined form lower layer header information (e.g., a sequence number, concatenation or segmentation related headers). For example, the header can be in the higher layer or the lower layer.

In certain representative embodiments, the receiving device may determine (e.g., by the higher layer entity), based on the indicating by the lower layer entity, the type of the PDU or the type of the second header in the PDU. The receiving device may decode the PDU based on the determined type of the PDU and/or type of the second header in the PDU.

In certain representative embodiments, L2 PDU headers may be handled using an implementation friendly design where a higher layer protocol knows (e.g., exactly) the size of the PDU header as well as how to decode the header upon receiving the PDU for processing.

In certain representative embodiments, protocol header processing may be enabled in hardware processes since the header size and/or type is known upon processing.

In certain representative embodiments, bulk processing may be performed on (e.g., most) packets with high data rates and dedicated processing (e.g., a dedicated processing unit) may be used for other (e.g., special) packets, such as segmented packets.

### Common Aspects and Features

In certain representative embodiments, higher or lower layer header may comprise a header or a sub-header which may be associated with an SDU. The header and the SDU may together form a PDU. The sub-header and the SDU may together form a sub-PDU. For example, a PDU may comprise one or more sub-PDUs.

For example, any of a PDU, sub-PDU, and/or header may be a bit string that is byte aligned (e.g., multiples of 8 bits) in length. As illustrated in the accompanying drawings, bit strings are represented by tables in which the most significant bit is a leftmost bit of the first line of the table, the least significant bit is a rightmost bit on the last line of the table. More generally, a bit string is to be read from left to right and then in the reading order of the lines (e.g., top to bottom). The bit order of each parameter field within a PDU is represented with the first and most significant bit in the leftmost bit and the last and least significant bit in the rightmost bit.

For example, a SDU may be a bit string that is byte aligned (e.g., multiple of 8 bits) in length. In general, a SDU may be included into a PDU from the first bit of the SDU onward.

### MAC Layer

In next generation wireless systems, the MAC (e.g., sub-) layer may remain an essential interface between the physical layer and other higher layers, such as controlling QoS and scheduling. In certain representative embodiments, the MAC layer may (e.g., should) remain as a component in a protocol layer design, such as to control the multiplexing of data flows, scheduling, and reporting control information reliably.

In certain representative embodiments, any of the following functionality may be provided by a MAC entity.

For example, a MAC entity may perform mapping between logical channels and transport channels, such as to ensure proper data flow.

For example, a MAC entity may perform multiplexing, or demultiplexing. The MAC sublayer may efficiently combine or separate MAC SDUs from different logical channels into, or from, transport blocks (TBs). TBs may then be delivered to, or from, the physical layer using transport channels.

For example, a MAC entity may perform scheduling information reporting, including scheduling requests and buffer status reports.

For example, a MAC entity may perform Hybrid Automatic Repeat Request (HARQ) processing. Error correction may be achieved through HARQ, such as where each cell (e.g., in the case of carrier aggregation (CA)) has a dedicated HARQ entity to handle retransmissions and ensure reliable data transmission.

For example, a MAC entity may perform dynamic scheduling. Prioritization of a WTRU 102 may be managed by dynamic scheduling, which allocates resources based on varying priorities to enhance overall system performance.

For example, a MAC entity may perform logical channel prioritization. Within a WTRU 102, logical channels may be assigned priorities to determine their order of resource allocation and/or access to the available transmission resources.

For example, a MAC entity may perform handling of overlapping resources. The MAC sublayer may efficiently manage overlapping resources within a single WTRU, including prioritization between dynamic grants, configured grants, and SR resources, such as to ensure optimal utilization.

For example, a MAC entity may perform processing of padding and control elements. The MAC sublayer (e.g., when necessary) may add padding bits to ensure proper alignment with the uplink grant size and the number of bits provided to the physical layer, such as after addition of all buffered data and triggered MAC control elements (MAC CEs).

### RLC Layer

In certain representative embodiments, any of the following functionality may be provided by a RLC (e.g., transmit) entity.

For example, a RLC transmit entity may perform ARQ retransmissions (AM).

For example, a RLC transmit entity may perform segmentation, such as for acknowledge mode (AM) and unacknowledged mode (UM) based on transport block size (TBS) and the size indicated by the MAC layer. As an example, the RLC entity may control the timing of PDU construction and delivery to lower layers, which may be determined based on the transmission time made available by the MAC layer, such as a function of grant availability, latency of data, and TB construction time. At such time, the RLC entity may determine whether segmentation is required for a given SDU. As an example, a retransmitted segment may be segmented (e.g., again). Assuming this type of retransmission is used instead of HARQ, the transmitting entity may need to keep track of a “segment tree” to recover a single PDU transmitted. For example, segmentation may be considered and/or implemented in other layers (e.g., in PDCP or MAC) in some (e.g., alternate) designs.

For example, a RLC transmit entity may perform concatenation (e.g., for AM and UM), such as in LTE but not in NR RLC. Such functionality may sit on top of MAC, with the aim to save on LCID/SN bytes.

For example, a RLC transmit entity may perform header addition (e.g., for AM and UM), including indication of sequence numbers, segment offset (SO), and segment information (SI) in cases of segmentation. As an example, sequencing may be considered as a redundant/induced functionality (e.g. when already performed in the PDCP layer).

For example, a RLC transmit entity may perform polling of a corresponding entity (e.g., for AM) for feedback for transmitted SDUs, such as asking for reception of status reports.

In certain representative embodiments, any of the following functionality may be provided by a RLC (e.g., receive) entity.

For example, a RLC receive entity may perform reassembly of PDUs of a segmented SDU and delivery to upper layers (e.g., for AM and UM). As an example, maintenance of a reception window and a timer for reassembly may be considered.

For example, a RLC receive entity may perform discarding of PDUs within an SDU that cannot be re-assembled due to loss (e.g., for UM). As an example, if a PDU that is a segment of an RLC SDU is lost, the remaining PDUs of the same SDU may be discarded, as there may not be a possibility to retransmit a lost PDU.

For example, a RLC receive entity may perform discarding of duplicate PDUs (e.g., for AM), such as may be due to PDCP duplication or due to an unnecessary retransmission due to an ACK/NACK HARQ feedback error. As an example, this functionality can be performed in combination with the PDCP layer in some design implementations.

For example, a RLC receive entity may perform delivery of ACK/NACK status reports per PDU (e.g., for AM).

In some representative embodiments, the PDCP layer may provide any of the functions listed above for RLC (e.g., sub-) layer.

### PDCP Layer

In certain representative embodiments, any of the following functionality may be provided by a PDCP entity.

For example, a PDCP entity may perform bearer management, such as data routing, split bearers, dual connectivity (DC), etc. Such constructs may be viewed as artificial bucketing of data and may not be strictly necessary. In some embodiments, DC may be viewed as not as important for (e.g., some) 6G deployment.

For example, a PDCP entity may perform packet duplication and routing.

For example, a PDCP entity may perform discarding of duplicates and/or outdated packets (e.g., duplication, FEC, duplicates resent due to HARQ NACK/ACK errors).

For example, a PDCP entity may perform integrity protection and ciphering.

For example, a PDCP entity may perform sequence numbering.

For example, a PDCP entity may perform reordering, such as in-/out-of order delivery (e.g., lost packets may come later, PDUs sent on multiple carriers may arrive at different timelines).

For example, a PDCP entity may perform retransmissions (e.g., FEC, upon handover for unacknowledged PDUs, RRC re-establishment, radio link failure (RLF)).

For example, a PDCP entity may perform out-of-order delivery, such as per QoS flow or on a SDU basis.

For example, a PDCP entity may perform error correction through ARQ (e.g., for AM only).

For example, a PDCP entity may perform segmentation and/or re-segmentation.

For example, a PDCP entity may perform reassembly of SDUs.

For example, a PDCP entity may perform marking QoS flow IDs (e.g., QFIs), such as in both DL and UL packets.

### Deployment Architecture and Functional Splits

In certain representative embodiments, a gNB 180 or a next generation (e.g., 6G) NB may be provided as a combined centralized unit (CU) and a distributed unit (DU) (e.g., no split). In certain representative embodiments, the CU and DU may be split and some functions (e.g., PDCP high, SDAP, or some core network functions) may be in the CU and other functions (e.g., RLC, PDCP low, MAC, PHY) may be at the DU. PDCP may also be implemented at the DU in some embodiments (e.g., to have a simple piece of equipment that will not have any layer 2 processing). In some embodiments, radio units (RUs) may be used and a gNB 180 or next generation NB may be provided (e.g., split) over a CU, DU, RU, where some functions (e.g., PHY, MAC, and/or RLC) may be located and managed at the RU.

In certain representative embodiments, a split between a DU and a RU may be in the mid PHY layer (e.g., where an upper PHY layer resides in the DU and a lower PHY layer resides in the RU). In certain representative embodiments, the user plane and the data plane may be terminated in different logical entities.

In certain representative embodiments, a functional split may refer to a split anywhere in the CU, DU, and/or RU at the transmit and/or the receive side of the protocol stack (e.g., at the WTRU 102 and/or NB).

The following terms may be used herein in the context of functional splits from the network's perspective:
C-Plane (Control Plane): Refer specifically to real-time control between the DU and the RU;
U-Plane (User Plane): Refers to user generated data and/or sample data transferred between the DU and the RU;
S-Plane (Synchronization Plane): Refers to traffic between the RU and/or the DU to a synchronization controller (e.g., synchronization controller messages);
High-PHY: Refers to portions of the PHY processing on the DU side of the fronthaul interface, including FEC encode/decode, scrambling, and modulation/demodulation; and
Low-PHY: Refers to portions of the PHY processing on the RU side of the fronthaul interface, including FFT/iFFT, digital beamforming, and PRACH extraction and filtering.

### User Plane Stack and Header Structures

In certain representative embodiments, the PDCP layer may handle data flows and/or QoS flows, and the MAC layer may handle schedules per data flow.

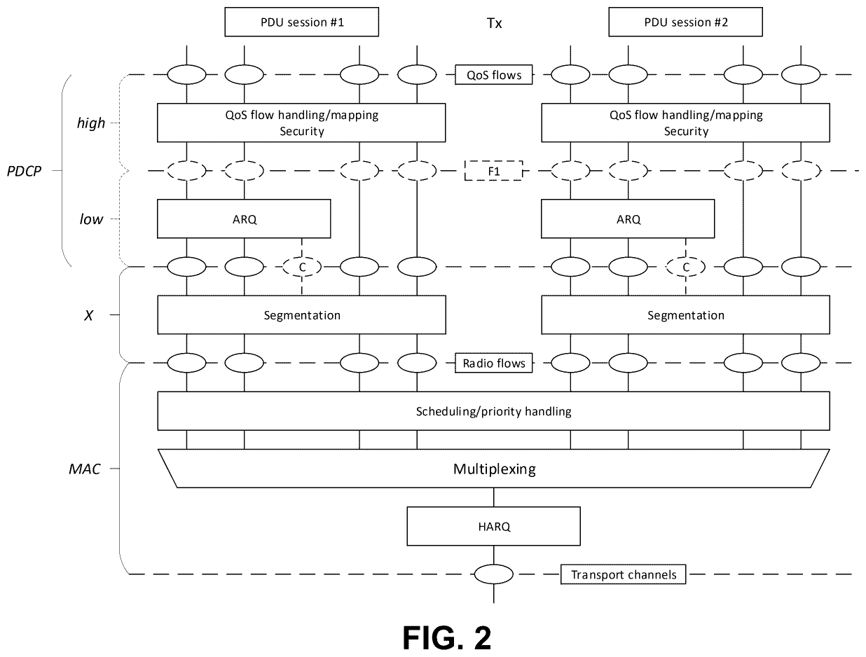

FIG. 2 is a protocol stack diagram illustrating an example of processing at various protocol layers at a transmitting entity, according to one or more embodiments of the present disclosure. For example, the (e.g., uplink) transmitting entity may be (e.g., implemented at) a WTRU 102. For example, the (e.g., downlink) transmitting entity may be (e.g., implemented at a next generation network node (e.g., 6G NB).

As shown in FIG. 2, a transmitting PDCP entity may receive SDUs from higher layers (e.g., data and/or QoS flows). For example, there may be one PDCP entity per each PDU session and/or service. For example, there may (e.g., alternatively) be two or more PDCP entities per PDU session and/or service, such as where multiple network entities are involved in the communication. As an example, there may be multiple PDCP entities when there are two or more DUs and/or two or more CUs like in the dual connectivity scenarios.

In some embodiments, a PDCP entity may handle each data flow separately (e.g., assign each data flow a different COUNT and/or SN). For example, a data flow ID may be part of a COUNT calculation where the data flow ID may construct a part of the COUNT. For example, the COUNT may be 32 or 40 bits long and the data flow ID may be part of the 8 most significant bits (MSBs) of the COUNT while the least significant bits (LSBs) of the COUNT may define the SN for the SDU of the data flow (e.g., 18 LSBs).

In some embodiments, the PDCP entity (e.g., protocol layer) may be split. As shown in FIG. 2, the PDCP layer may be split into a PDCP-high sublayer and a PDCP-low sublayer where some of the functionality in the PDCP transmitting entity is handled by a PDCP-high entity and the remaining part by a PDCP-low entity.

For example, the PDCP-high entity may associate the COUNT and/or SN for each SDU of a data flow, perform security (e.g., ciphering and/or integrity protection (IP)) on a data flow basis, perform header compression (e.g., like robust header compression (RoHC) or ethernet header compression (EHC)), associate a timer for each SDU (e.g., discard timer), create the PDCP header for a SDU (e.g., SN, data flow ID, etc.), and the like. The PDCP-high entity may also map certain data flows to ARQ functionality in the PDCP-low entity.

For example, the PDCP-low may perform ARQ functionality, such as performing retransmissions, polling, etc.

For example, the PDCP-high and PDCP-low entities may be implemented by a single entity. As an example on the network side, the PDCP-high and PDCP-low entities may both reside in the CU, or in the DU. As another example, the PDCP-high entity may be deployed in the CU and the PDCP-low entity may be deployed in the DU. For example, a network interface may be provided for use between the PDCP-high and PDCP-low entities. For example, the network interface may be a F1-interface or any equivalent fronthaul interface (e.g., between the CU and DU).

As another example on the WTRU side, the PDCP-high and PDCP-low entities may be implemented by a single PDCP entity.

In FIG. 2, the functionality of the ‘X’ layer may be implemented by the PDCP entity (e.g., PDCP-low), may be a separate entity (e.g., RLC or the like), or may be implemented by the MAC entity. For example, an X layer entity may perform segmentation and/or buffering of the data from data flows before transmission.

For example, the X layer may map data to MAC PDUs based on the MAC scheduler decisions and may not add any headers for any X layer SDU that is not segmented. As an example, for (e.g., only) the X layer SDUs that need to be eventually segmented into a MAC PDU, the X layer may add a segmentation header which may include information, such as segmentation information (e.g., whether the segment is a first, middle or last segment of the SDU, or whether the segment is the last segment of the SDU or not) and/or a sequence number used by the receiver side to combine segments belonging to the same SDU. In one example, the sequence number used for segmenting may be the PDCP SN or a subset thereof. In one example, the SN may be a (e.g., separate) SN assigned by the X layer.

In some embodiments, the X layer functionality may not be part of the PDCP entity (e.g., is implemented by an RLC entity or MAC entity). For example, if the X layer functionality is not part of the PDCP entity, the X layer may provide information to the ARQ entity on what segments of data flow SDU(s) have been mapped to a lower layer PDU or MAC PDU.

In some embodiments, a MAC entity may schedule transmission data on a per data flow basis (e.g., radio flows in FIG. 2). For example, the MAC entity may be aware of and/or serve the data flows (e.g., QoS flows). For example, the MAC entity (e.g., at the WTRU 102) may be configured with rules on how to schedule the data flows into a MAC PDU.

As an example, the configuration may be on a per QoS flow basis, and/or the MAC entity may get packet-based information from the higher layers (e.g., with respect to each SDU of a data flow and/or per data flow). For example, packet-based information may include any of the following: QoS class marking (e.g. from higher layers); a RAN QoS treatment profile (e.g., associated with a QoS class marking); a packet priority; a packet importance; a packet delay budget or remaining time; a data type (e. g, systematic, SRB, AI/ML, sensing, dependent/multi-modal data, FEC data); PDU set related information; a transport layer protocol (e.g., whether QUIC is used/out of order is already done at transport layer); a packet data volume; a network energy saving (NES) state, a WTRU power saving state; and/or a data treatment flow marking which may represent data flow or PDU association (e.g., inter-flow dependency).

For example, the MAC entity may add a MAC sub-header for each MAC SDU. The sub-header may include information associated with and/or relating to the SDU for the receiving MAC entity. As examples, a MAC sub-header may include information indicating any of a PDCP entity ID; PDU session ID (e.g., based on which the receiving MAC entity may determine the PDCP entity where to map the data); whether the SDU is segmented (e.g., by the X layer, PDCP entity, or RLC entity) based on which the receiving MAC entity may map the SDU to X layer processing or may indicate to the X layer whether the SDU is segmented so that the proper header processing can be performed; and/or SDU length.

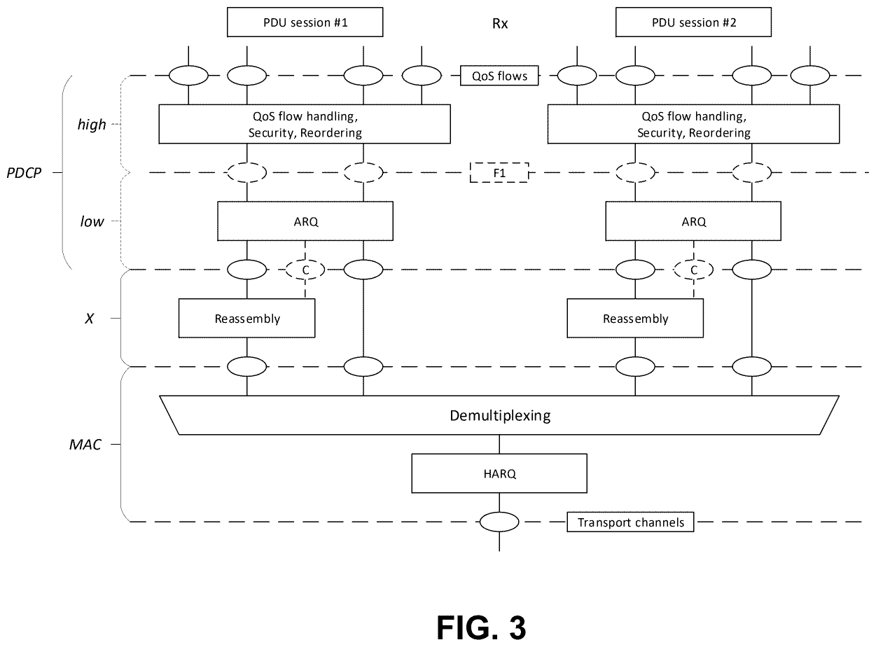

FIG. 3 is a protocol stack diagram illustrating an example of processing at various protocol layers at a receiving entity, according to one or more embodiments of the present disclosure. For example, the (e.g., uplink) receiving entity may be (e.g., implemented at) a next generation network node (e.g., 6G NB). For example, the (e.g., downlink) receiving entity may be (e.g., implemented at) a WTRU 102.

As shown in FIG. 2, the receiving MAC entity receives MAC PDUs from lower layers and demultiplexes the content of the MAC PDUs into MAC SDUs.

In certain representative embodiments, the receiving MAC entity may determine from the MAC SDU sub-header to which PDCP entity the SDU is to be forwarded. For example, the receiving MAC entity may (e.g., also) determine from the MAC SDU sub-header whether the MAC SDU is a segmented higher layer SDU based on which the receiving MAC entity may forward the SDU to the ‘X’ layer for reassembly (e.g., when segmented) or directly to PDCP processing (e.g., when not segmented).

In some embodiments, the X layer at the receiving entity may be implemented by the MAC entity, by the PDCP entity, or may be a separate layer/entity (e.g., like the RLC entity).

For example, any MAC SDUs that are not segmented by the transmitting X layer may be (e.g., directly) passed to the PDCP entity through a logical interface. In some embodiments, the X layer may be implemented by the RLC entity, and RLC Transparent Mode (TM) may be used for the logical interface.

In some embodiments, any MAC SDUs that are segmented by the transmitting X layer may be passed to the receiving X layer for processing. For example, the X layer (e.g., which may be implemented in the MAC, RLC or PDCP layer) may buffer any segments and perform reassembly of multiple segments to form a higher layer SDU. For example, the X layer (e.g., if not part of the PDCP functionality) may provide information about the received segments to the ARQ functionality in the PDCP entity. As an example, the X layer may pass any reassembled SDUs to the PDCP entity.

As shown in FIG. 3, the PDCP entity may receive SDUs from the X layer. In some embodiments, the PDCP entity may receive SDUs directly from the MAC layer. The PDCP enetity may performs functions and/or operations (e.g., on the SDUs) per data flow.

For example, a data flow that does not require ARQ, or is not configured with ARQ, may be deciphered and put in a reordering buffer (e.g., if reordering required), or (e.g., alternatively) directly passed to higher layers.

For example, a data flow that requires ARQ may be deciphered and placed in the reordering buffer (e.g., if reordering required), or may bedirectly passed to higher layers and the SN is logged in the ARQ functionality.

In certain representative embodiments, ARQ functionality may be performed on a per data flow basis where the STATUS reports by the receiving PDCP entity may be transmitted on a per data flow basis. In some embodiments, one or more data flows may be combined in a single STATUS report. For example, a STATUS report may include a data flow ID and the highest acknowledgement SN for the given data flow ID and one or more negative acknowledgement SN(s) for the given data flow ID. After this, information about another data flow ID may be added into the same STATUS report.

For example, a STATUS report may be composed on a priority order of data flows. A most important data flow ID and its information may be placed first in the STATUS report so that if the information needs to be truncated (e.g., there is not a grant large enough to transmit the whole STATUS report) at least the highest priority data flow(s) may be reported.

In certain representative embodiments, ARQ functionality may be implemented by the PDCP lower layer so that status reporting may be performed without fronthaul interface latency. As examples, the ARQ functionality may be placed in the CU or the DU at the network side (e.g., based on network implementation).

In certain representative embodiments, fine granularity scheduling (e.g., on data flow basis) may provide for the prioritizing of data on a per packet and/or flow basis to achieve improved QoE.

In certain representative embodiments, data flow specific handling in the radio UP stack may avoid any head of line blocking issues between different flows.

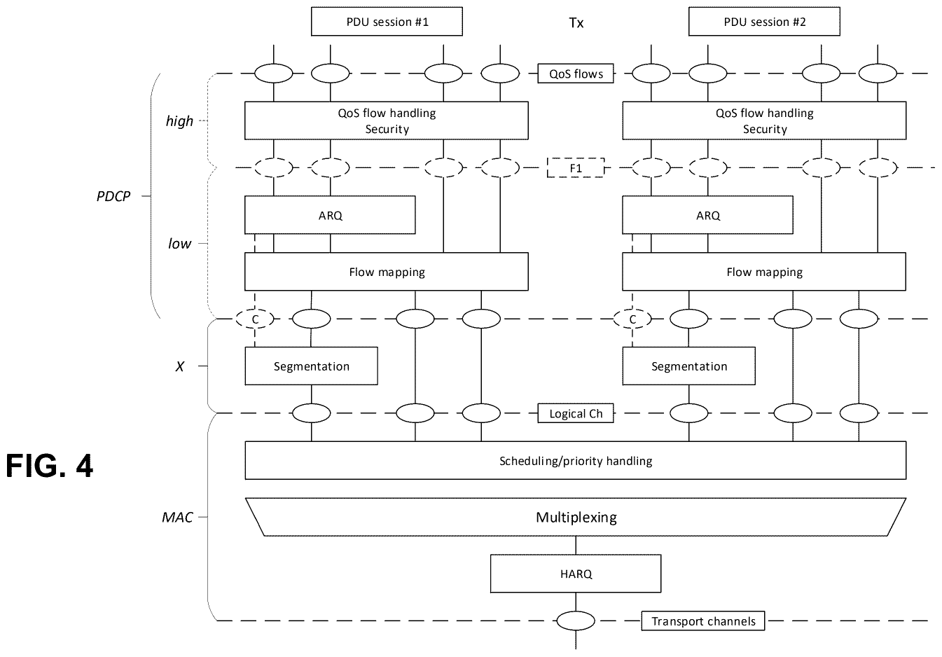

FIG. 4 is a protocol stack diagram illustrating another example of processing at various protocol layers at a transmitting entity, according to one or more embodiments of the present disclosure. For example, the (e.g., uplink) transmitting entity may be (e.g., implemented at) a WTRU 102. For example, the (e.g., downlink) transmitting entity may be (e.g., implemented at a next generation network node (e.g., 6G NB). As shown in FIG. 4, a (e.g., transmitting) PDCP entity may handle data flows and/or QoS flows, and a (e.g., transmitting) MAC entity may perform scheduling per logical channel. In FIG. 4, the PDCP entity may implement additional functionality in mapping the data flows into logical channels

In certain representative embodiments, a PDCP entity (e.g., PDCP low in the network) may implement a flow mapping functionality that is based on rules and packet characteristics may map data to logical channels. For example, the mapping rules may include or be based on any of the following: (i) a QoS class marking (e.g., from higher layers); (ii) a RAN QoS treatment profile (e.g., associated with a QoS class marking); (iii) packet priority; (iv) packet importance; (v) a packet delay budget or remaining time; (vi) data type (e.g., systematic, SRB, AI/ML, sensing, dependent/multi-modal data, FEC data); (vii) PDU set related information; (viii) transport layer protocol (e.g., whether QUIC is used/out of order is already done at transport layer); (ix) packet data volume; (x) NES/UE power saving state; and/or (xi) a data treatment flow marking which may represent a data flow or PDU association (e.g., inter-flow dependency).

For example, logical channels where the flow mapping functionality maps the data from the data flows may have different characteristics or may be characterized, such as in terms of any of the following: (i) priority; (ii) prioritized bit rate; (iii) bucket size duration; (iv) segmentation possibility or no segmentation at all; (v) packet delay budget (PDB) or remaining time; (vi) data flow IDs allowed to be mapped; and/or (vii) a data treatment flow marking which may represent a data flow or PDU association (e.g., inter-flow dependency).

In certain representative embodiments, the MAC layer may (e.g., then) schedule the logical channels based on the characteristics of the logical channels and the amount of data they have. For example, a logical channel ID may (e.g., need to) be indicated in the MAC SDU sub-header for the receiving MAC entity to be able to forward the data to a proper PDCP entity. As another example, a similar approach as described herein may be used where a MAC sub-header of an SDU (e.g., only) indicates the PDCP entity ID and/or PDU session ID, and other information of the SDU (e.g., a PDCP entity ID, a header type, and/or whether it is segmented or not, or other information described herein). The PDCP entity may then handle the flow mapping as described herein.

In certain representative embodiments, less granular scheduling may be required by the MAC entity which may be beneficial in that the configuration of a WTRU 102 may be less complex to be performed and/or implemented.

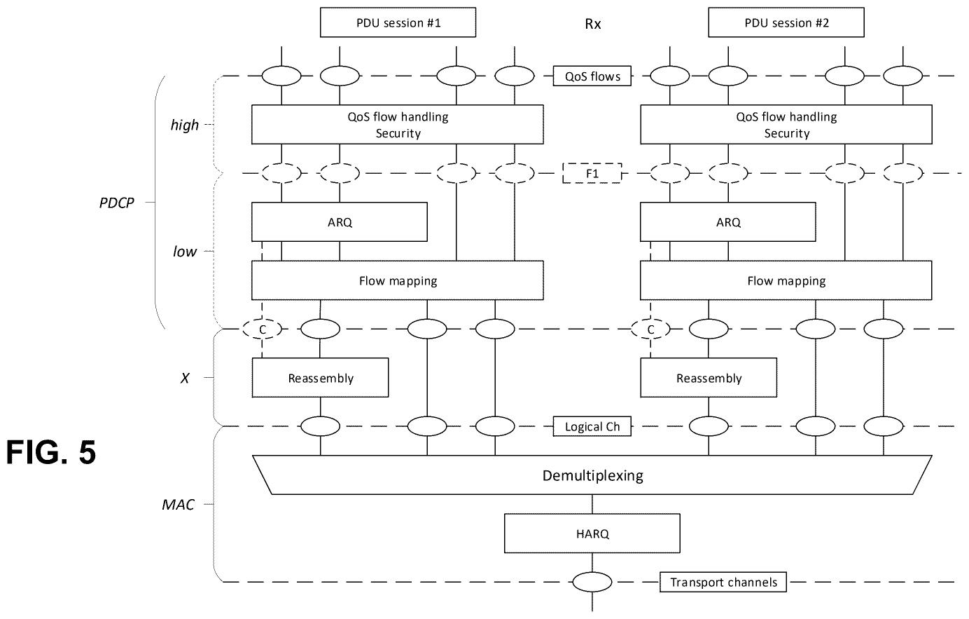

FIG. 5 is a protocol stack diagram illustrating another example of processing at various protocol layers at a receiving entity, according to one or more embodiments of the present disclosure. For example, the (e.g., uplink) receiving entity may be (e.g., implemented at) a next generation network node (e.g., 6G NB). For example, the (e.g., downlink) receiving entity may be (e.g., implemented at) a WTRU 102. As shown in FIG. 5, the

As shown in FIG. 5, a (e.g., receiving) PDCP entity may handle data flows and/or QoS flows, and a (e.g., receiving) MAC entity may perform functionality similar to FIG. 3. In general, the receiving-side protocol layers may provide counterpart functionality similar to the transmission-side protocol layers shown in FIG. 4.

### Lower Layer Header Formats

In certain representative embodiments, the term “lower layer” may refer to any of MAC, RLC, or any other layer/sublayer, such as those defined for 6G systems.

In certain representative embodiments, a lower layer PDU header may indicate (e.g., include information indicating) a type of a corresponding SDU or a corresponding higher layer PDU. For example, the type may indicate whether the SDU, or PDU, is a data PDU, a control PDU, a PDU with a special header type, a segmented PDU, a concatenated PDU, or the like. For example, the type may indicate a header type of the corresponding SDU or PDU. For example, a data PDU header, a control PDU header, a segmentation header, a special header, a concatenated PDU header, or the like. For example, the type may indicate any one or more of the above. For example, a 2-bit field may be used for this purpose. For example, the type may indicate a configuration to the higher layer(s) as to how to process the received PDU.

In certain representative embodiments, the type may be related to the upper layer header processing and/or a structure assumption. For example, if there are different assumptions configured, the lower layer header may point to a header assumption of the higher layer or vice-versa. For example, the lower layer header may indicate the header structure used by the higher layer. For example, a WTRU 102 may be predefined and/or configured with a header assumption mapping table between a lower layer and the higher layer (e.g., where a lower layer header value ‘x’ points to a higher layer header assumption ‘y’, and so forth).

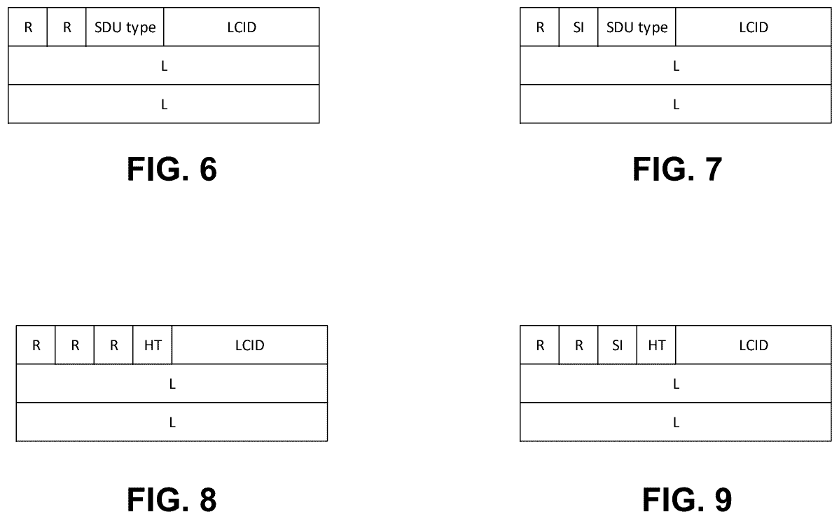

FIG. 6 is a lower layer header diagram illustrating an example of a lower layer PDU sub-header, according to one or more embodiments of the present disclosure. As shown in FIG. 6, a lower layer header may include one or more reserved (R) bits and/or fields, an SDU type (e.g., indication) field, a logical channel ID (LCID) field, and a length (L) field.

In certain representative embodiments, the lower layer header may be a lower layer (e.g., PDU) sub-header. For example, the sub-header may be a data PDU sub-header (e.g., including a higher layer SDU). The LCID may indicate any of a PDCP entity, PDU session, and/or logical channel associated with the SDU. The L field may indicate the size of the SDU (e.g., as a number of bytes). The SDU type field may indicate the type of the corresponding SDU to be indicated to the higher layer by the lower layer receiving entity (e.g., MAC entity).

FIG. 7 is a lower layer header diagram illustrating another example of a lower layer PDU sub-header, according to one or more embodiments of the present disclosure. As shown in FIG. 7, a lower layer header may include one or more reserved (R) bits, a segmentation information (e.g., indication) (SI) field, an SDU type (e.g., indication) field, a logical channel ID (LCID) field, and one or more length (L) fields.

In certain representative embodiments, the lower layer header may be a lower layer (e.g., PDU) sub-header.

In certain representative embodiments, a lower layer (e.g., PDU) sub-header may include a (e.g., dedicated) field indicating whether the higher layer PDU is a segmented PDU or not.

FIG. 8 is a lower layer header diagram illustrating another example of a lower layer PDU sub-header, according to one or more embodiments of the present disclosure. As shown in FIG. 8, a lower layer header may include one or more reserved (R) bits, a header type (e.g., indication) field, a logical channel ID (LCID) field, and one or more length (L) fields.

In certain representative embodiments, the lower layer header may be a lower layer (e.g., PDU) sub-header.

In certain representative embodiments, a lower layer (e.g., PDU) header may include information indicating (e.g., an indication) whether a special header type (HT) is included for the corresponding SDU, or PDU, or whether the HT is a normal data PDU header type. For example, a special header type field may indicate whether the corresponding PDU includes a segmented SDU, a control, PDU, a data PDU, polling information, reordering is not required, reflective flow mapping indicator(s), a concatenated PDU, or the like. For example, a normal data PDU header type may include a SN and a data flow ID (e.g., QFI). For example, a 1-bit field may be used for the purpose.

FIG. 9 is a lower layer header diagram illustrating another example of a lower layer PDU sub-header, according to one or more embodiments of the present disclosure. As shown in FIG. 8, a lower layer header may include one or more reserved (R) bits, a SI field, a HT field field, a logical channel ID (LCID) field, and a length (L) field.

In certain representative embodiments, a lower layer header may be a lower layer (e.g., PDU) sub-header.

In certain representative embodiments, the lower layer header may include information indicating (e.g., an indication) whether the higher layer PDU is a segmented PDU or not. For example, the lower layer header may include a (e.g., dedicated) SI field to indicate whether the higher layer PDU is a segmented PDU or not.

As shown in FIGS. 6 to 9, a lower layer header may include a set of R bits (e.g., which are reserved for future use(s)). For example, an (e.g., one) R bit may indicate whether the sub-PDU (e.g., sub-header and data) is a data sub-PDU (as in the examples above) or a control sub-PDU (e.g., a MAC CE).

In certain representative embodiments, a lower layer PDU may be formed by multiplexing and/or concatenating one or more lower layer sub-PDUs. For example, each sub-PDU may include a PDU sub-header (e.g., as described herein, such as in FIGS. 6 to 9) and an SDU.

In certain representative embodiments, a lower layer header may include any (e.g., combination) of the fields shown in FIGS. 6-9.

### Higher Layer Header Formats

In certain representative embodiments, the term “higher layer” may refer to any of RLC, PDCP, SDAP, or any other layer/sublayer, such as those defined for 6G systems.

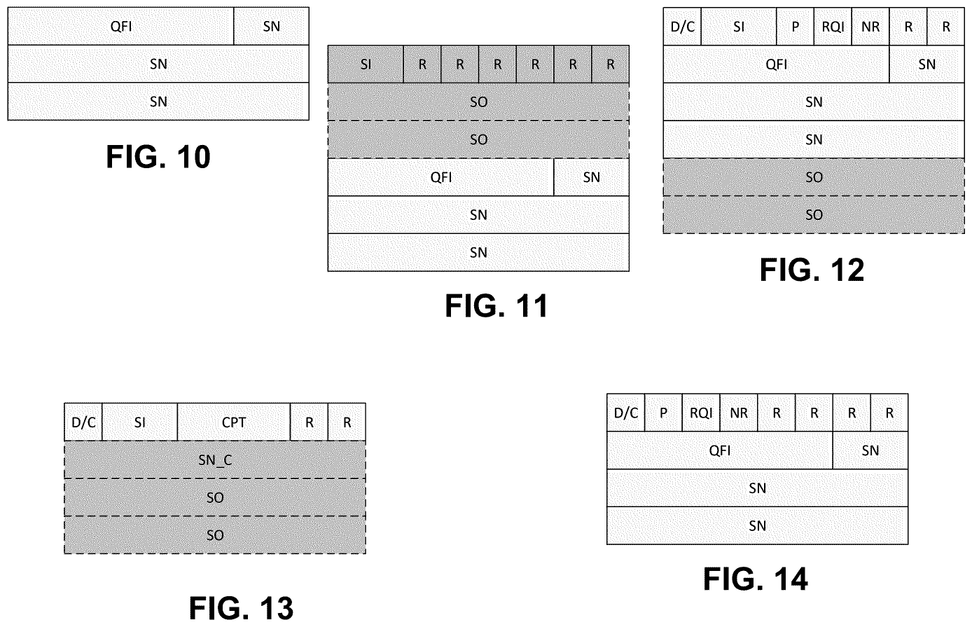

FIG. 10 is a higher layer header diagram illustrating an example of a higher layer data PDU header, according to one or more embodiments of the present disclosure. As shown in FIG. 10, a higher layer data PDU header may include a QFI (QoS Flow ID), or other data flow ID, and a SN which may be a sequence number. As another example, a higher layer data PDU header may (e.g., also or alternatively) include a COUNT value. For example, the COUNT value may be composed of a hyper frame number (HFN) and the SN (e.g., a size of the HFN part in bits may be equal to 32 minus the length of the SN).

In certain representative embodiments, a higher layer header of the type shown in FIG. 10, for example, may be used for any data PDU and associated with any data SDU (e.g., which does not need to convey any other specific information). For example, the higher layer header of FIG. 10 may be a (e.g., most) optimized header type from an overhead perspective.

FIG. 11 is a higher layer header diagram illustrating another example of a higher layer data PDU header, according to one or more embodiments of the present disclosure. As shown in FIG. 11, the higher layer header may be a higher layer segmented data PDU header that includes (e.g., in addition to the fields described in FIG. 10) a SI field (e.g., which includes information indicating whether he segmented SDU is a first segment, a middle segment, or a last segment), a SO field, and one or more R bits and/or R fields. For example, the SI may be a 1-bit field indicating whether the segment is the last segment or another segment. The SO field may include information indicating a position of the current segment (e.g., in bytes within the original SDU). For example, the presence of the SO field may be optional and may be subject to whether the segment is a first segment of the SDU or not (e.g., not present for a first segment).

In certain representative embodiments, the segment header part may be encoded or decoded by the same higher layer entity as the QFI and/or SN, or may be encoded or decoded by a different higher layer entity. For example, the segment header part could be encoded or decoded by an RLC or a PDCP entity, while the QFI and/or SN header part could be encoded or decoded by a (e.g., different) PDCP entity.

FIG. 12 is a higher layer header diagram illustrating another example of a higher layer data PDU header, according to one or more embodiments of the present disclosure. As shown in FIG. 12, a higher layer data PDU header may be a special header that includes (e.g., in addition to the fields described in FIGS. 10 and 11), a Data/Control (D/C) field, a polling (P) field, a reflective QoS indication (RQI) field, and/or a no reordering (NR) field.

In certain representative embodiments, the D/C field may include information indicating whether the SDU is a data SDU or a control SDU. The P field may include information indicating to the receiving higher layer entity whether a status report should be triggered. The RQI field may include information indicating to the receiving higher layer entity whether the corresponding data flow should be mapped to a different QoS flow, bearer, logical channel, and/or the like. The NR field may include information indicating to the receiving higher layer entity that the corresponding SDU may not require reordering and/or in-sequence delivery to upper layers.

For example, the presence of the SO field may be optional and may be subject to whether the SDU is segmented and/or whether the segment is a first segment of the SDU or not (e.g., not present for a full SDU or the first segment).

FIG. 13 is a higher layer header diagram illustrating an example of a higher layer control PDU header, according to one or more embodiments of the present disclosure. As shown in FIG. 13, a higher layer data PDU header may be a header that includes (e.g., in addition to the fields described in FIGS. 10 to 12) a control PDU type (CPT) field and/or a sequence number for control (SN_C) field.

In certain representative embodiments, a CPT field may include information indicating a type of the corresponding control in the PDU (e.g., a status report, header compression related control, data compression related control, etc.).

In certain representative embodiments, a SN_C field may include information indicating a sequence number allocated for the control PDU. For example, the presence of such a sequence number may be optional and subject to whether the control PDU is segmented or not. Similarly, the SO field may be optionally present and subject to whether the control PDU is segmented or not.

FIG. 14 is a higher layer header diagram illustrating another example of a higher layer data PDU header, according to one or more embodiments of the present disclosure. As shown in FIG. 14, a higher layer data PDU header may be a (e.g., special) header that includes one or more of the fields described in FIGS. 10 to 12. For example, the higher layer header of FIG. 14 may be used when special information on top of or in addition to the QFI and/or SN is included in the higher layer header.

In certain representative embodiments, a separate segmentation header, such as in FIG. 11, may be used and/or combined with the higher layer header of FIG. 14.

In certain representative embodiments, a higher layer header may include any (e.g., combination) of the fields shown in FIGS. 10-14.

### Higher and Lower Layer Indications

In certain representative embodiments, information indicated (e.g., indications) between the higher and the lower layers may be based on specified means or may be achieved through implementation means or may be predefined or configured.

In certain representative embodiments, cross layer indications may be useful to reduce header overhead, WTRU 102 computational complexity, and/or reduce TB preparation time.

For example, one or more indications may be implicit (e.g., by the higher layer entity to lower layer entity), such as based on one or more logical channels associated with one or more types of PDUs or headers of PDUs. As an example, different logical channels may be defined (e.g., within a device according to specification and/or implementation) for each type of a PDU and/or header.

For example, one or more indications may be explicit (e.g., by the higher layer entity to lower layer entity) about the type of the PDU, or the lower layer SDU, and/or the type of the header in the PDU.

As an example, an indication may comprise an index to be encoded by the lower layer entity into a second header. For example, the lower layer entity may not need to know what the index actually means and the index may be (e.g., only) used to convey such information to the receiving entity. For example, index values and their meanings may be specified by the higher layer specification or in the lower layer specification.

In certain representative embodiments, the (e.g., transmitting) higher layer entity may indicate to the (e.g., transmitting) lower layer entity whether one or more header fields need to be generated, can be skipped, or can be reused and/or determined from higher layer header information (e.g., a sequence number, concatenation or segmentation related headers). For example, a lower layer header may be conditionally present as a function of whether an associated higher layer header is present or not (e.g., a sequence number, concatenation or segmentation related headers). For example, a lower layer header may be conditionally present as a function of whether an associated SDU is segmented or concatenated. For example, a lower layer header may be conditionally present as a function of a value of an associated higher layer header (e.g., within a range, less than a threshold, or greater than a threshold). As an example, a lower layer SN may be skipped or not generated, such as if the higher layer SN is incremented by the same amount, or if the lower layer SN matches the sequence of the higher layer header.

In certain representative embodiments, the (e.g., receiving) lower layer entity may indicate whether one or more header field are present, skipped, can be reused and/or determined form lower layer header information (e.g. a sequence number, concatenation, and/or segmentation related headers). For example, the header may be in the higher layer (e.g., a higher layer header) or the lower layer (e.g., a lower layer header). For example, a lower layer header may be used to conditionally indicate to higher layers the presence of a header in the higher layer as a function of whether an associated lower layer header is present or not (e.g. a sequence number, concatenation, and/or segmentation related headers). For example, a lower layer header may be conditionally present as a function of whether the associated packet is segmented or concatenated. For example, a higher layer header may be conditionally present as a function of the value of an associated lower layer header (e.g., within a range, less than a threshold, or greater than a threshold). In one example, a lower layer SN may be be skipped or not generated if a higher layer SN is present (e.g., a higher layer header may be present if the associated lower layer header is missing from the received PDU).

In certain representative embodiments, a header may be (e.g., conditionally) present if the associated SDU is delivered to lower layers out of order. For example, a header may be conditionally present (e.g., not performed) if integrity protection and/or security is performed, or not, in a higher layer. For example, a header may be conditionally present (e.g., performed) if integrity protection is performed in the same layer for which the header applies. For example, a header may be conditionally present (e.g., not generated) if integrity protection is skipped or is performed jointly with another associated SDU or PDU (e.g., whereby another header is generated for the aggregate). For example, a header may be conditionally present (e.g., performed) if segmentation and/or concatenation is performed in the same layer for which the header applies.

In certain representative embodiments, a header or a header type may be conditionally included, or not generated, as a function of at least one of the following: (i) data latency; (ii) processing time; (iii) packet and/or data rates; (iv) packet type; (v) application and/or service type; (vi) configuration per data channel and/or QoS flow; and/or (vii) sequence information. For example, a header or a header type may be conditionally included, or not generated, as a function of data latency, such as if the remaining time (e.g., the time until discard or until the packet delay budget expires) is less than a threshold. For example, a header or a header type may be conditionally included, or not generated, as a function of processing time, such as the header may be skipped if the time until the start of the transmission is less than a threshold, or if the time from grant reception until transmission start is less than a threshold. For example, a header or a header type may be conditionally included, or not generated, as a function of packet rate and/or data rate, such as the header may be skipped if the preserved throughput is higher than a configured threshold and/or if a header for an associated PDU (e.g., within a set) is included. For example, a header or a header type may be conditionally included, or not generated, as a function of packet type, such as data type, control, sensory, head of line packet, end of set packet, and/or high importance packet). For example, a header or a header type may be conditionally included, or not generated, as a function of application type and/or service type, such as if an indication is received or not from an application layer, transport layer, or an application layer interface. For example, a header or a header type may be conditionally included, or not generated, as a function of a configuration per data channel and/or a configuration per QoS flow, such as a subset of data flow may be configured or predefined to generate one or more header types. For example, a header or a header type may be conditionally included, or not generated, as a function of sequence information, such as whether an upper layer header and/or SN is sufficient or indicated.

### PDU Formation and Data Flow

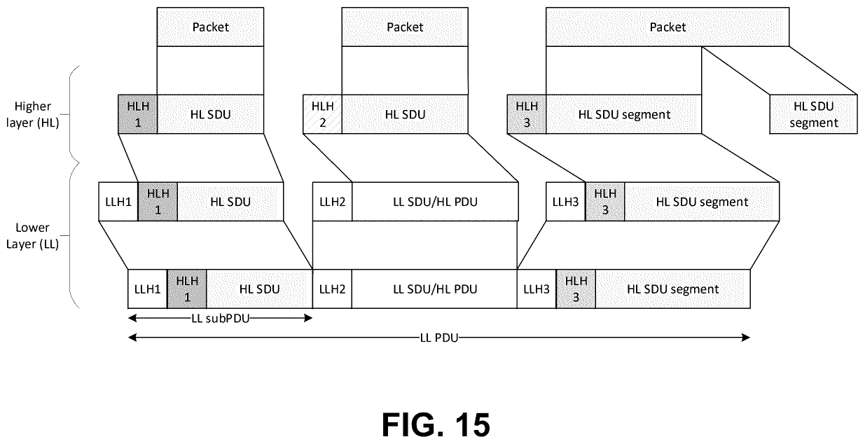

FIG. 15 is a data structure diagram illustrating an example header and data unit hierarchy, according to one or more embodiments of the present disclosure. As shown in FIG. 15, (e.g., data) packets may be received from one or more upper layers by a higher layer (HL) for processing by a HL entity. For example, the upper layers may be any of an application layer and/or non-access stratum (NAS) layer. For example, a packet may be regarded as a HL SDU. For example, a data packet may be produced by the HL (e.g., a control packet).

In certain representative embodiments, the HL entity may include (e.g., attach) HL headers (HLH) to the packets. For example, the packets may be referred to as HL SDUs (e.g., when accompanied by a HLH). For example, a HLH may be determined according to information to be encoded therein.

For example, in FIG. 15 for the leftmost HL SDU, the HLH (e.g., HLH1) may include a special HLH format or a control header format, such as shown in FIGS. 12-14. For example, for the middle HL SDU, the HLH (e.g., HLH2) may include a data PDU header, such as shown in FIG. 10. For example, for the rightmost HL SDU, the HLH (e.g., HLH3) may include a segmented PDU header as the rightmost packet is segmented (e.g., by the transmitter), such as shown in FIGS. 11 and 12. As used herein, the HLH may be referred to as a first header at the transmission side. As used herein, the HLH may be referred to as a second header at the reception side.

In certain representative embodiments, a HLH and a HL SDU may (e.g., be combined to) form a HL PDU, or a lower layer (LL) SDU. For example, in FIG. 15, the middle data packet is associated with a combination of HLH2 and a corresponding HL SDU.

In certain representative embodiments, a lower layer (LL) entity may include (e.g., attach) LL headers (LLH) to the HL SDUs (or HL PDUs or LL SDUs) based on the type of the HLH and/or type of the HL SDU (or HL PDUsor LL SDU).

For example, as shown in FIG. 15, the LLH1 may indicate the type of the HL PDU, LL SDU, and/or HLH1. By the LLH1 indicating the type of the HL PDU, LL SDU, and/or HLH1, a receiver HL entity may determine the type of HL PDU, LL SDU, and/or HLH1 and may determine, for example, that the HLH1 has a specific size (e.g., 1 or 4 bytes), and/or that the HLH 1 includes polling information (e.g., a polling bit P). With these determinations, the receiver HL entity may be able to effectively process the HL SDU (or HL PDU), such as by knowing the exact size of the HLH1 and/or by knowing that the HLH1 includes specific fields, such as the polling bit P, and may invoke processes handling polling even before processing the HLH1.

For example, the LLH2 may indicate the type of the HL PDU, LL SDU, and/or HLH2. By the LLH2 indicating the type of the HL PDU, LL SDU, and/or HLH2, the receiver HL entity may determine the type of the HL PDU, LL SDU, and/or HLH2 and may determine, for example, that the HLH2 has a specific size (e.g., 3 bytes), and/or that the HLH2 includes (e.g., only) data processing related information (e.g., sequence number SN). With these determinations, the receiver HL entity may be able to effectively process the HL PDU, such as by knowing the exact size of the HLH2 and/or by knowing that the header does not include any specific fields that would require invoking control processes, such as status reporting.

For example, the LLH3 may indicate the type of the HL PDU, LL SDU, and/or HLH3. By the LLH3 indicating the type of the HL PDU, LL SDU, and/or HLH3, the HL receiver entity may determine the type of the HL PDU, LL SDU, and/or HLH3, and may determine, for example, that the HLH3 has a specific size (e.g., 6 bytes), and/or that the HLH 3 includes segmentation information and/or (e.g., is) a segmentation header. With these determinations, the receiver HL entity may be able to effectively process the HL PDU, such as by knowing the exact size of the HLH3 and/or by knowing that the header includes a segmentation header and, hence, may place the HL PDU directly to a different receiver buffer given the HL PDU does not include a full data packet (but rather a segment thereof).

In certain representative embodiments, a LLH may be referred to as a sub-header. As used herein, the LLH may be referred to as a second header at the transmission side. As used herein, the LLH may be referred to as a first header at the reception side.

In certain representative embodiments, a LLH and a LL SDU (or HL PDU) may (e.g., be combined to) form a LL sub-PDU. For example, the LL may multiplex one or more sub-PDUs to form a LL PDU. As shown in FIG. 15, the LL multiplexes three LL sub-PDUs to form a LL PDU.

In other representative embodiments, a LL PDU may include a LLH, a HLH, and a HL SDU, or LL SDU/HL PDU (e.g., without the use of a LL sub-PDU structure).

### Example Solutions

In certain representative embodiments, a lower layer PDU header may provide (e.g., indicate) information about how a higher layer entity shall decode a higher layer PDU and/or higher layer PDU header.

In certain representative embodiments, a WTRU 102 may perform transmission as described herein. In certain other representative embodiments, a base station (e.g., a gNB 180, a 6G NB, or the like) may perform transmission as described herein.

In certain representative embodiments, a higher layer (e.g., transmitting) entity (e.g., of a WTRU 102) may determine that a packet (e.g., such as from another higher layer) is to be transmitted. For example, the packet may be any of a data packet, a control packet, a data SDU, or a data PDU (e.g., generated by the higher layer entity).

In certain representative embodiments, the higher layer (e.g., transmitting) entity may generate a first PDU that includes a first header and the packet to be transmitted. For example, the header may depend on the type of the packet and/or one or more pieces of information to be encoded in the header. For example, the type of the packet may be a data SDU or a control SDU. For example, the one or more pieces of information may include one or more of a SN, data flow ID (e.g., QFI), segmentation information (e.g., SI and/or SO), polling information, a reordering/in-sequence requirement, concatenation information, security information (e.g., MAC-I or key), reflective QoS information, and/or the like.

In certain representative embodiments, the higher layer (e.g., transmitting) entity may indicate, to a lower layer (e.g., transmitting) entity, the type of the first PDU, a type of the lower layer SDU, and/or the type of the header in the first PDU. For example, the lower layer entity may be a MAC or RLC entity. For example, the indication may be implicit, such as based on one or more logical channels associated with one or more types of PDUs or headers of PDUs. For example, the indication may be explicit by the higher layer entity to the lower layer entity about the type of the first PDU, the type of the lower layer SDU, and/or the type of the header in the first PDU. For example, the indication may include an index to be encoded by the lower layer entity into a second header. As an example, the lower layer entity may not need to know what the index actually means and/or relates to and the index may be used to convey information to a receiving entity.

In certain representative embodiments, the lower layer (e.g., transmitting) entity may generate (e.g., at least in part based on the indication by the higher layer entity) a second header, or a sub-header, for the SDU. For example, the second header may include information on the type of the SDU, the type of the higher layer PDU, and/or the type of the first header. For example, this information may indicate whether the SDU, or higher layer PDU, is a data PDU, a control PDU, a PDU with a special header type, a segmented PDU, a concatenated PDU, and/or the like. As another example, this information may indicate whether the first header in the (e.g. higher layer) PDU is a data PDU header, a control PDU header, a segmentation header, a special header, a concatenated PDU header, and/or the like. As another example, this information may indicate a combination of any of the above. For example, a 2-bit field may be used for this purpose.

For example, this information may be related to upper layer header processing and/or a structure assumption (e.g., regarding the upper layer header). As an example, the first (e.g., higher layer) header may have different processing and/or structure assumptions (e.g., configured), and the second (e.g., lower layer) header may include information indicating (e.g., pointing) to a header assumption (e.g., a header structure of the first header) for the higher layer, or vice versa.

In certain representative embodiments, the lower layer (e.g., transmitting) entity may generate a second PDU. For example, the second PDU may include a (e.g., at least one) sub-PDU, and the sub-PDU may include the second (e.g., lower layer) header, the first (e.g., higher layer) header, and the SDU (or higher layer PDU). For example, the SDU may be the first PDU. As an example, the second PDU may include multiple sub-PDUs, where each sub-PDU includes a respective second header, respective first header, and respective SDU (or higher layer PDU).

For example, the second generated PDU may be provided to other lower layers for further processing (e.g., multiplexing) and transmission over the air interface for reception.

In certain representative embodiments, a WTRU 102 may perform reception as described herein. In certain other representative embodiments, a base station (e.g., a gNB 180, a 6G NB, or the like) may perform reception as described herein.

In certain representative embodiments, a lower layer (e.g., receiving) entity (e.g., of a WTRU 102) may receive a first PDU. For example, the first PDU may correspond to the second generated PDU from the lower layer transmitting entity. For example, the first PDU may include a (e.g., at least) sub-PDU, and the sub-PDU may include a first (e.g., lower layer) header, a second (e.g., higher layer) header, and a SDU (or higher layer second PDU). For example, the lower layer entity may be a MAC entity or a RLC entity.

In certain representative embodiments, the lower layer (e.g., receiving) entity may determine information from the first header. For example, the information may include, or otherwise indicate, a type of the SDU (or corresponding higher layer PDU) and/or a type of the second (e.g., higher layer) header. For example, this information may indicate whether the SDU (or second PDU) is a data PDU, a control PDU, a PDU with a special header type, a segmented PDU, a concatenated PDU, and/or the like. For example, the information may indicate whether the header in the PDU is a data PDU header, a control PDU header, a segmentation header, a special header, a concatenated PDU header, etc. For example, the information may also indicate any combination of the above. For example, a 2-bit field may be used for this purpose.

For example, this information may be related to the second (e.g., upper layer) header processing and/or structure assumption (e.g., regarding the upper layer header). For example, if there are different assumptions configured, the lower layer header points to the header assumption (e.g., a header structure of the second header) of the higher layer (e.g., SDU/higher layer second PDU), or vice versa.

In certain representative embodiments, the lower layer (e.g., receiving) entity may indicate, to a higher layer (e.g., receiving) entity, a type of the SDU, the higher layer second PDU, and/or a type of the second header. For example, the indication may be implicit, such as based on one or more logical channels associated with one or more types of PDUs or headers of PDUs. For example, the indication may be explicit indication by the lower layer entity to the higher layer entity about the type of the lower layer SDU, the second PDU, and/or the type of the header in the second PDU.

In certain representative embodiments, the higher layer (e.g., receiving) entity may determine, based on the indicating by the lower layer (e.g., receiving) entity, the type of the second PDU and/or the type of the second header in the second PDU. For example, the higher layer (e.g., receiving) entity may decode the second PDU based on the determined type of the second PDU and/or the determined type of the second header in the second PDU.

In certain representative embodiments, a lower layer (e.g., sub-layer) PDU may be received. A lower layer PDU header (e.g., of the lower layer PDU) may include information indicating how to process (e.g., decode) a higher layer PDU header and/or higher layer PDU carried in the lower layer PDU. For example, a lower layer entity may be a MAC entity in some embodiments. For example, the lower layer PDU header may be a MAC sub-header in some embodiments. For example, a higher layer entity may be an RLC entity or a PDCP entity in some embodiments. For example, the higher layer PDU header may be a RLC PDU header or a PDCP PDU header in some embodiments.

In certain representative embodiments, the lower layer PDU header may indicate a type of the corresponding SDU and/or the corresponding higher layer PDU. As an example, the type may indicate whether the SDU (or PDU) is any of a data PDU, a control PDU, a PDU with a special header type, a segmented PDU, and/or a concatenated PDU. As an example, the type may indicate the header type of the corresponding SDU (or PDU). For example, a data PDU header, a control PDU header, a segmentation header, a special header, and/or a concatenated PDU header. For example, the type may be indicated as any (e.g., combination of) one or more of the foregoing. For example, a 2-bit field may be used for this purpose.

As a more general example, the type maybe related to the upper layer header processing and/or structure assumption. For example, if there are different assumptions configured, the lower layer header may point to the header assumption of the higher layer or vice-versa (e.g., indicates the header structure used by the higher layer).

In certain representative embodiments, the lower layer PDU header may indicate whether a special header type is included for the corresponding SDU (or PDU) and/or whether the header type is a normal data PDU header type. As an example, a special header type may indicate whether the corresponding PDU includes a segmented SDU, a control PDU, a data PDU, polling information, that reordering is not required, a reflective flow mapping indicator(s), and/or a concatenated PDU. As an example, a normal data PDU header type may include a SN and a data flow ID (e.g., QFI). For example, a 1-bit field may be used for this purpose.

In certain representative embodiments, the lower layer indication to the higher layer about the SDU, PDU, and/or header type may be based on distinct logical channels within the device (e.g., different logical channels for control, data, segmented data, special header, etc.) or based on indication(s) by the lower layer along with submitting the SDU to higher layer processing.

In certain representative embodiments, the lower layer encodes the lower layer PDU header with the information about the higher layer PDU based on distinct logical channels within the device (e.g., different logical channels for control, data, segmented data, etc.) or based on indication(s) by the higher layer upon submitting the higher layer PDU for transmission by the lower layer.

In certain representative embodiments, the higher layer protocol may know exactly the size of the PDU header as well as how to decode the header upon receiving the PDU for processing which may be beneficial from an implementation design perspective.

In certain representative embodiments, protocol header processing may be enabled in hardware processes since the header size and/or type may be known upon (e.g., higher layer) processing.

In certain representative embodiments, packets may be processed (e.g., in bulk) with high data rates. In certain representative embodiments, a dedicated processing unit may be provided for special packets (e.g., segmented packets).

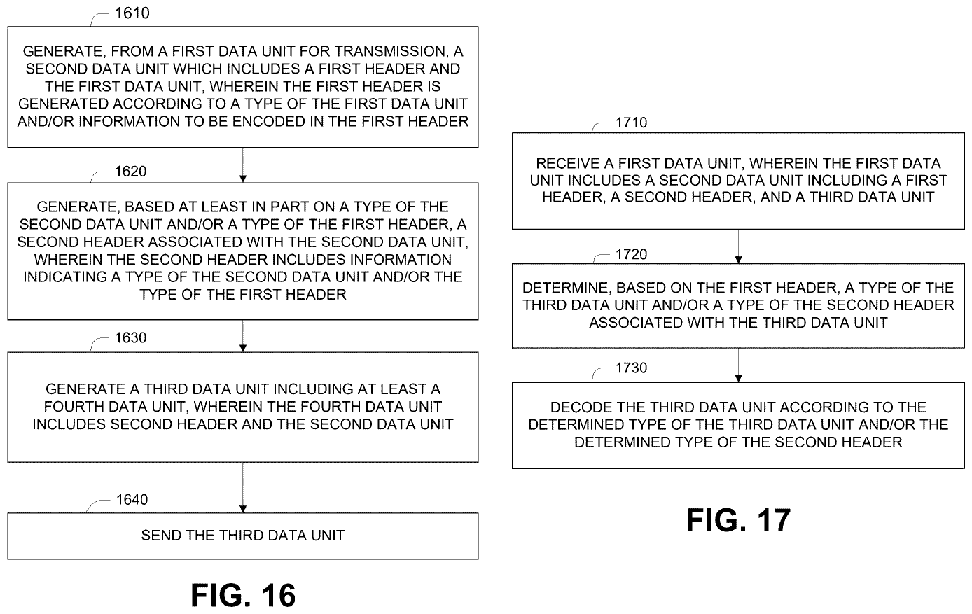

FIG. 16 is a procedural diagram illustrating an example transmission procedure, according to one or more embodiments of the present disclosure. For example, a WTRU 102 may implement the procedure, such as for uplink communication. As another example, a base station (e.g., gNB 180, a 6G NB) may implement the procedure, such as for downlink communication.

As shown in FIG. 16, the procedure may include to generate, from a first data unit (e.g., packet, SDU from an upper layer) for transmission, a second data unit (e.g., a HL SDU) which includes a first header (e.g., a HLH) and the first data unit at 1610. For example, the first header may be generated according to a type of the first data unit and/or information to be encoded in the first header. At 1620, the procedure may include to generate, based at least in part on a type of the second data unit and/or a type of the first header, a second header (e.g., a LLH) associated with the second data unit. For example, the second header includes information indicating a type of the second data unit and/or the type of the first header. At 1630, the procedure may include to generate a third data unit (e.g., a LL PDU) including at least a fourth data unit (e.g., a LL sub-PDU). For example, the fourth data unit may include the second header and the second data unit (e.g., the HLH1 and HL SDU). At 1640, the procedure may include to send the third data unit.

In some representative embodiments, the third data unit may include the second header and the second data unit (e.g., without the fourth data unit). The third data unit which includes the second header and the second data unit may be sent (e.g., submitted to lower layer processing for transmission).

In some representative embodiments, the first data unit may be any of a data SDU, a data packet, a control SDU, or a control packet.

In some representative embodiments, the information to be encoded in the first header may include any of one or more SNs, flow IDs, segmentation information, polling information, reordering or in-sequence requirement information, concatenation information, security information, and/or reflective QoS information.

In some representative embodiments, the second data unit may be a (e.g. lower layer or lower sub-layer) PDU.

In some representative embodiments, the information indicating the type of the second data unit and/or the type of the first header may be based on one or more logical channels. For example, certain logical channel(s) may be associated with the type of the second data unit and/or the type of the first header.

In some representative embodiments, the second header may be a sub-header for the second data unit.

In some representative embodiments, the second header may include information indicating the second data unit is any of a data PDU, a control PDU, a PDU with a special header type, a segmented PDU, or a concatenated PDU. For example, the second header may include information indicative of the type of the second data unit.

In some representative embodiments, the second header includes information indicating the second header is a data PDU header, a control PDU header, a special header, a segmentation header, or a concatenation header. For example, the second header may include information indicative of the type of the second header.

In some representative embodiments, the second header may include information indicating a structure (e.g., format) of the first header.

In some representative embodiments, the fourth data unit may be a sub-PDU.

FIG. 17 is a procedural diagram illustrating an example reception procedure, according to one or more embodiments of the present disclosure. For example, a WTRU 102 may implement the procedure, such as for downlink communication. As another example, a base station (e.g., gNB 180, a 6G NB) may implement the procedure, such as for uplink communication.

As shown in FIG. 17, the procedure may include to receive a first data unit (e.g., a LL PDU) at 1710. For example, the first data unit may include a second data unit (e.g., a LL sub-PDU) including a first header (e.g., a LLH), a second header (e.g., a HLH), and a third data unit (e.g., a HL SDU). At 1720, the procedure may include to determine, based on the first header, a type of the third data unit and/or a type of the second header associated with (e.g., of) the third data unit. At 1730, the procedure may include to decode the third data unit according to the determined type of the third data unit and/or the determined type of the second header.

In some representative embodiments, the second data unit may be a LL sub-PDU.

In some representative embodiments, the first header may include information indicating a structure (e.g., format) of the second header.

In some representative embodiments, the first header may include information indicating the first header is a data PDU header, a control PDU header, a special header, a segmentation header, or a concatenation header. For example, the first header may be indicative of a type of the first header.

In some representative embodiments, the first header may include information indicating the second data unit is any of a data PDU, a control PDU, a PDU with a special header type, a segmented PDU, or a concatenated PDU. For example, the first header may be indicative of a type of the second data unit.

In some representative embodiments, the first header may include information indicating the first data unit is any of a data PDU, a control PDU, a PDU with a special header type, a segmented PDU, or a concatenated PDU. For example, the first header may be indicative of a type of the first data unit.

In some representative embodiments, the first header may be a sub-header for the third data unit.

In some representative embodiments, the information indicating the type of the third data unit and/or the type of the second header may be based on one or more logical channels. For example, certain logical channel(s) may be associated with the type of the third data unit and/or the type of the second header.

In some representative embodiments, the first data unit may be a (e.g., lower layer or lower sub-layer) PDU.

In some representative embodiments, information encoded in the first header may include any of one or more SNs, flow IDs, segmentation information, polling information, reordering or in-sequence requirement information, concatenation information, security information, and/or reflective QoS information.

In some representative embodiments, the procedure may include to obtain (e.g., decode) the second data unit from the first data unit. For example, the third data unit may be decoded from the second data unit, and the decoded third data unit includes a fourth data unit.

In some representative embodiments, the third data unit may be any of a data SDU, a data packet, a control SDU, or a control packet.

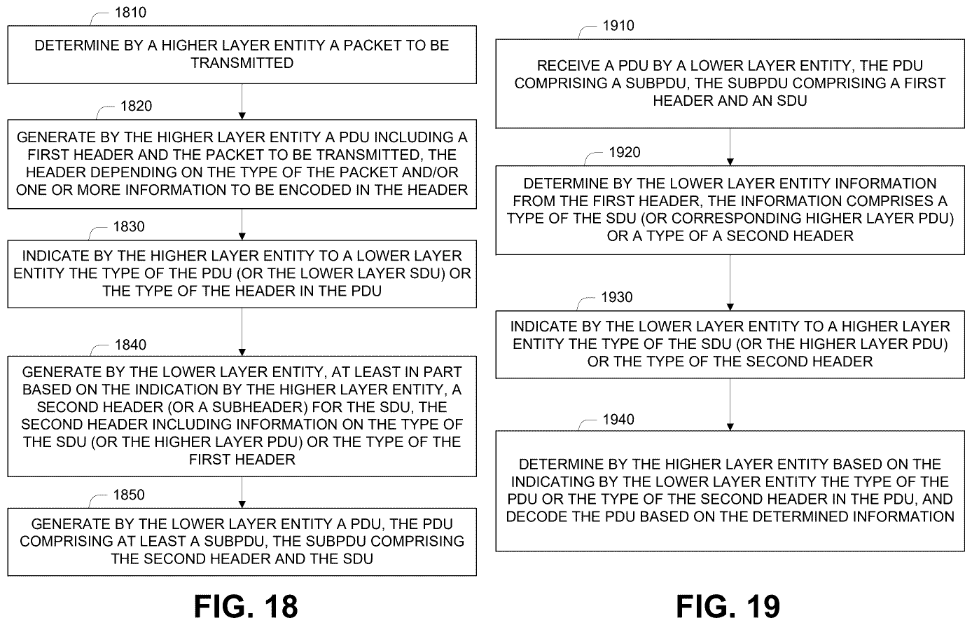

FIG. 18 is a procedural diagram illustrating another example transmission procedure, according to one or more embodiments of the present disclosure. For example, a WTRU 102 may implement the procedure, such as for uplink communication. As another example, a base station (e.g., gNB 180, a 6G NB) may implement the procedure, such as for downlink communication.

As shown in FIG. 18, the procedure may include to determine by a higher layer entity a packet to be transmitted at 1810. At 1820, the higher layer (e.g., sub-layer) entity may generate a PDU including a first header and the packet to be transmitted. The first header may be dependent on the type of the packet and/or one or more pieces of information to be encoded in the header. At 1830, the higher layer entity may indicate to a lower layer (e.g., sub-layer) entity the type of the PDU (or the lower layer SDU) and/or the type of the header in the PDU. At 1840, the lower layer entity may generate, at least in part based on the indication by the higher layer entity, a second header (or a sub-header) for the SDU. For example, the second header may include information on the type of the SDU (or the higher layer PDU) and/or the type of the first header. At 1850, the lower layer entity may generate a (e.g., LL) PDU. For example, this PDU may include at least a sub-PDU, and the sub-PDU may include the first header, the second header, and the SDU.

FIG. 19 is a procedural diagram illustrating another example reception procedure according to one or more embodiments of the present disclosure. For example, a WTRU 102 may implement the procedure, such as for uplink communication. As another example, a base station (e.g., gNB 180, a 6G NB) may implement the procedure, such as for downlink communication.

As shown in FIG. 19, the procedure may include to receive a (e.g., a LL) PDU by a lower layer entity at 1910. This PDU may include a sub-PDU, and the sub-PDU may include a first header, a second header, and an SDU. At 1920, the lower layer entity may indicate to a higher layer entity the type of the SDU (or the higher layer PDU) and/or the type of the second header. For example, the lower layer may determine the indicated information from the first header. At 1930, the higher layer entity may determine, based on the indicating by the lower layer entity, the type of the PDU and/or the type of the second header in the PDU, and decode the PDU based on the determined information (e.g., type of the PDU and/or type of the second header in the PDU).

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

What is claimed is:

1. A wireless transmit/receive unit (WTRU) comprising:
a processor, memory, and a transceiver which are configured to:
generate, from a first data unit for transmission, a second data unit which includes a first header and the first data unit, wherein the first header is generated according to a type of the first data unit and/or information to be encoded in the first header,
generate, based at least in part on a type of the second data unit and/or a type of the first header, a second header associated with the second data unit, wherein the second header includes information indicating a type of the second data unit and/or the type of the first header,
generate a third data unit including at least a fourth data unit, wherein the fourth data unit includes the second header and the second data unit, and
send the third data unit.

2. The WTRU of claim 1, wherein the first data unit is any of a data service data unit (SDU), a data packet, a control SDU, or a control packet.

3. The WTRU of claim 1, wherein the information to be encoded in the first header includes any of one or more sequence numbers (SNs), a flow identifier (ID), segmentation information, polling information, reordering or in-sequence requirement information, concatenation information, security information, and/or reflective quality of service (QoS) information.

4. The WTRU of claim 1, wherein the second data unit is a protocol data unit (PDU).

5. The WTRU of claim 1, wherein the information indicating the type of the second data unit and/or the type of the first header is based on one or more logical channels associated with the type of the second data unit and/or the type of the first header.

6. The WTRU of claim 1, wherein the second header is a subheader for the second data unit.

7. The WTRU of claim 1, wherein the second header includes information indicating the second data unit is any of a data protocol data unit (PDU), a control PDU, a PDU with a special header type, a segmented PDU, or a concatenated PDU.

8. The WTRU of claim 1, wherein the second header includes information indicating the second header is a data protocol data unit (PDU) header, a control PDU header, a special header, a segmentation header, or a concatenation header.

9. The WTRU of claim 1, wherein the second header includes information indicating a structure of the first header.

10. The WTRU of claim 1, wherein the fourth data unit is a sub-protocol data unit (sub-PDU).

11. A transmission method implemented by a wireless transmit/receive unit (WTRU), the method comprising:
generating, from a first data unit for transmission, a second data unit which includes a first header and the first data unit, wherein the first header is generated according to a type of the first data unit and/or information to be encoded in the first header;
generating, based at least in part on a type of the second data unit and/or a type of the first header, a second header associated with the second data unit, wherein the second header includes information indicating a type of the second data unit and/or the type of the first header;
generating a third data unit including at least a fourth data unit, wherein the fourth data unit includes the second header and the second data unit; and
sending the third data unit.

12. The method of claim 11, wherein the first data unit is any of a data service data unit (SDU), a data packet, a control SDU, or a control packet.

13. The method of claim 11, wherein the information to be encoded in the first header includes any of one or more sequence numbers (SNs), a flow identifier (ID), segmentation information, polling information, reordering or in-sequence requirement information, concatenation information, security information, and/or reflective quality of service (QoS) information.

14. The method of claim 11, wherein the second data unit is a protocol data unit (PDU).

15. The method of claim 11, wherein the information indicating the type of the second data unit and/or the type of the first header is based on one or more logical channels associated with the type of the second data unit and/or the type of the first header.

16. The method of claim 11, wherein the second header is a subheader for the second data unit.

17. The method of claim 11, wherein the second header includes information indicating the second data unit is any of a data protocol data unit (PDU), a control PDU, a PDU with a special header type, a segmented PDU, or a concatenated PDU.

18. The method of claim 11, wherein the second header includes information indicating the second header is a data protocol data unit (PDU) header, a control PDU header, a special header, a segmentation header, or a concatenation header.

19. The method of claim 11, wherein the second header includes information indicating a structure of the first header.

20. The method of claim 11, wherein the fourth data unit is a sub-protocol data unit (sub-PDU).

21.-48. (canceled)
